(19) United States
(12) Patent Application Publication
(10) Pub. No.: US 2005/0260515 A1
(43) Pub. Date: Nov. 24, 2005

(54) Electrostatic-latent-image developing toner and full-color image-forming method

(75) Inventors: Hiroaki Kato, Itami-shi (JP); Masahiro Anno, Hachioji-shi (JP); Chikara Tsutsui, Nishinomiya-shi (JP); Takeshi Arai, Akashi-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Konica Minolta Business Technologies, Inc., Chiyoda-ku (JP)

(21) Appl. No.: 10/777,104

(22) Filed: Feb. 13, 2004

(30) Foreign Application Priority Data
Sep. 8, 2003 (JP) 2003-315235

(51) Int. Cl. G03G 9/09

(52) U.S. Cl. 430/108.6; 430/126

(57) ABSTRACT

A toner comprising: toner particles that are manufactured by a wet granulating method and contain a binder resin and a colorant; and
composite oxide fine particles having a specific surface area of not more than 300 m²/g, that contain two kinds or more of metal atoms selected from the group consisting of metal atoms that belong to 4A to 7A groups, 8 group and 1B to 4B groups in the long-period-type element periodic table, and an image-forming method using the toner thereof.

This application is based on application(s) No. 2003-315235 filed in Japan, the contents of which are hereby incorporated by reference.

### BACKGROUND OF THE INVENTION

1. Field of the Invention

The present invention relates to an electrostatic-latent-image developing toner to be used for a copying machine, a printer and the like, and a full-color image-forming method.

2. Description of the Related Art

Conventionally, in the electrostatic-latent-image developing toner, the quantity of charge has been adjusted by using a charge-controlling agent such as nigrosine and quaternary ammonium salt. However, as the technique of a post-treatment agent to be externally added to and mixed with toner particles has been developed, it becomes possible to adjust the quantity of charge by using a post-treatment agent. With respect to the method, a method in which post-treatment agents of two or more different kinds are added so as to adjust the quantity of charge based upon the ratio of the addition or the like has been proposed.

In the case when a toner having a small particle size with the average particle size of not more than 10 μm is used, a high quantity of charge is required in comparison with toners having a large particle size, and the resulting problem is degradation in the charging stability, with respect to environmental fluctuations and continuous use. In particular, the degradation in the charging stability due to continuous use is caused by the fact that the application of two or more kinds of different post-treatment agents causes only one kind of the post-treatment agent selectively to come off the surface of the toner particle due to continuous use, resulting in imbalance in charging and the subsequent difficulty in maintaining the initial charging properties. When there is a reduction in the charging stability, it becomes difficult to obtain a desired quantity of charge at the time of an environmental fluctuation and/or continuous use (endurance printing process), resulting in fogging and a reduction in the image density. In particular, in the case of a toner obtained through a wet granulating method, since the toner has a greater moisture-absorbing property in comparison with a toner obtained through a pulverizing method, it is subjected to serious degradation in the charging stability (in particular, charging stability with respect to environmental fluctuations).

### SUMMARY OF THE INVENTION

The present invention is to provide an electrostatic-latent-image developing toner that is superior in charging stability against continuous use and environmental fluctuations, and capable of providing an image virtually free from fogging and degradation in the image density for a long time, as well as a full-color image-forming method using such a toner.

Another objective of the present invention is to provide an electrostatic-latent-image developing toner that is superior in charging stability against continuous use and environmental fluctuations, and capable of providing an image virtually free from fogging, filming and degradation in the image density for a long time, as well as a full-color image-forming method using such a toner.

The present invention relates to a toner comprising:
toner particles that are manufactured by a wet granulating method and contain a binder resin and a colorant; and
composite oxide fine particles having a specific surface area of not more than 300 m²/g, that contain two kinds or more of metal atoms selected from the group consisting of metal atoms that belong to 4A to 7A groups, 8 group and 1B to 4B groups in the long-period-type element periodic table, and an image-forming method using the toner thereof.

### BRIEF DESCRIPTION OF THE DRAWING

FIG. 1 is a schematic structural drawing that shows a full-color image-forming apparatus to which a full-color image-forming method that preferably uses a toner of the present invention is applied.

### DETAILED DESCRIPTION OF THE INVENTION

The present invention relates to a toner comprising:
toner particles that are manufactured by a wet granulating method and contain a binder resin and a colorant; and
composite oxide fine particles having a specific surface area of not more than 300 m²/g, that contain two kinds or more of metal atoms selected from the group consisting of metal atoms that belong to 4A to 7A groups, 8 group and 1B to 4B groups in the long-period-type element periodic table, and an image-forming method using the toner thereof.

The toner of the present invention is superior in the charging stability against continuous use and environmental fluctuations. The application of the toner of the present invention makes it possible to form an image that is virtually free from generation of fogging and degradation in the image density, for a long period of time. By regulating the lower limit value of the BET specific surface area of the composite oxide fine particles contained in the toner, it becomes possible to properly prevent generation of filming.

The electrostatic-latent-image developing toner of the present invention contains toner particles and specific composite oxide fine particles. The state of the presence of the composite oxide fine particles is not particularly limited, and, for example, the composite oxide fine particles may be externally added so as to be located in the vicinity of the surface of the toner particle, or may be added (internally added) in a toner particle manufacturing process so as to be located inside the toner particle. In the present invention, from the viewpoint of effectively adjusting the toner quantity of charge, the composite oxide fine particles are preferably added to toner particles externally so as to be located in the vicinity of the surface of the toner particle. In the present specification, the term, “externally added”, refers to the fact that fine particles are added to and mixed with the toner particle that has been preliminarily obtained.

The following description will discuss a case in which the composite oxide fine particles are externally added to the toner particles, and a description to be given to a case in which the composite oxide fine particles are internally added thereto is the same as the following description given to the case in which those are externally added, except that the composite oxide fine particles are added in the toner particle manufacturing process and that the resulting composition oxide fine particles are mainly located inside the toner particle.

In the present invention, the composite oxide fine particles to be used in the present invention contains two kinds or more of metal atoms selected from the group consisting of metal atoms that belong to 4A to 7A groups, 8 group and 1B to 4B groups in the long-period-type element periodic table, more preferably the group consisting of Si, Al, Ti, Zr, Fe, Nb, V, W, Sn and Ge. More specifically, each of the composite oxide fine particles is composed of a metal oxide of not less than two kinds of the above-mentioned metal atoms. Preferable examples of the metal oxide that can constitute each fine particle include: SiO₂, Al₂O₃/TiO₂, ZrO₂, Fe₂O₃, Nb₂O₅, V₂O₅, WO₃, SnO₂, GeO₂ and the like. The structure of the composite oxide fine particles is not particularly limited as long as each fine particle contains two or more kinds of the above-mentioned metal atoms, and, examples thereof include a structure in which two or more kinds of metal atoms are chemically or physically bonded to each other through oxygen atoms, a structure in which two or more kinds of metal atoms are chemically or physically bonded to each other without using oxygen atoms, or a composite structure of these structures.

From the viewpoint of effectively improving the charging stability against continuous use and environmental fluctuations, the composite oxide fine particles preferably contain at least Si. From the viewpoint of easiness in obtaining the material, the composite oxide fine particles preferably contain Si and Ti.

The composition of the composite oxide fine particles is not particularly limited as long as the effects of the present invention are achieved, the ratio of contents of the two or more kinds of metal atoms in the fine particles is set to not less than 10 number %, preferably not less than 20 number %, with respect to the number of the entire metal atoms contained in the fine particles. The ratio of contents of metal atoms can be measured by a fluorescent X-ray analyzer XRF-1800 (made by Shimadzu Corp.).

For example, in the case when the composite oxide fine particles are constituted by only two kinds of metal oxides, the ratio of contents between one metal oxide and the other metal oxide is set to 1:9 to 9:1, preferably 2:8 to 8:2, in the molar ratio. In the present invention, the composite oxide fine particles may contain metal atoms other than the above-mentioned metal atoms, as long as the effects of the present invention are obtained.

The BET specific surface area of the composite oxide fine particles is set to not more than 300 m²/g. When the specific surface area is too large, the fine particles tend to be embedded in the toner particle, causing degradation in the charging stability and fluidity upon endurance printing process. In the present invention, by setting the specific surface area of the composite oxide fine particles to not less than 5 m²/g, it becomes possible to effectively prevent occurrence of filming and spent fine particles. When the specific surface area is too small, the fine particles are easily separated from the toner particle upon endurance printing process, the separated fine particles tend to remain on the surface of the photosensitive member, causing filming on an image and the subsequent noise. When the separated fine particles are spent and adhere to a charging member (carrier blade), the charging stability deteriorates, causing problems of fogging and a reduction in the image density. In the present invention, from the viewpoint of improving the charging stability against continuous use and environmental fluctuations as well as of preventing occurrence of fogging and filming upon endurance printing process and a reduction in the image density, the BET specific surface area of the composite oxide fine particles is preferably set in a range of 30 to 250 m²/g, more preferably 50 to 200 m²/g, still more preferably 120 to 180 m²/g.

The above-mentioned composite oxide fine particles can be manufactured by using a vapor method. The vapor method refers to a method in which a material compound containing metal atoms is heated to be vaporized so that the resulting gas is burned to provide metal oxide fine particles.

More specifically, first, a material compound is heated to be vaporized, and the resulting gas is transferred into a known mixing chamber with a burner together with an inert gas, for example, nitrogen. The material compound is not particularly limited, as long as it contains desired metal atoms, and can be vaporized, and a chloride is normally used preferably. Specific examples of the preferable material compound include: SiCl₄, AlCl₃, TiCl₄, ZrCl₄, FeCl₃, NbCl₅, VOCl₃, WOCl₄, WCl₆, SnCl₄, GeCl₄ and the like Two or more kinds are selected from these compounds and used so that composite oxide fine particles contain desired metal atoms. In the case when two or more kinds of the material compounds are used, the corresponding material compounds may be vaporized together to be transferred into the mixing chamber, or may be vaporized and transferred separately, and mixed in the mixing chamber. The rate of use of these material compounds is directly reflected to the ratio of contents of the metal atoms in the fine particles; therefore, by adjusting the rate of use, it becomes possible to control the metal atoms in the fine particles.

After having transferred thereto, the gas is further mixed with hydrogen, air and/or oxygen in the mixing chamber, and burned in the mixing chamber so that composite oxide fine particles are obtained. Upon collecting the composite oxide fine particles, a filter is preferably used. The surface of the composite oxide fine particle obtained in this method normally has the material compound, in particular, the above-mentioned metal chloride adhering thereto; therefore, by making the fine particles in contact with moistened air at a temperature in a range of 500 to 700° C., it becomes possible to remove the material compound and dry the fine particles.

The composite oxide fine particles need not be manufactured by the above-mentioned vapor method, and any method may be used as long as it can manufacture metal oxide fine particles containing specific metal atoms. For example, methods, such as a hydrolysis method, a laser abrasion method and a liquid-phase method, may be adopted.

The composite oxide fine particles are preferably subjected to a hydrophobizing process to have a degree of hydrophobicity of not less than 20%, preferably not less than 40%. Thus, it becomes possible to further improve the charging stability against continuous use and environmental fluctuations, in particular, the charging stability against environmental fluctuations. In the case when the composite oxide fine particles are manufactured by the above-mentioned vapor method, after having removed the material compound adhering to the surface of the fine particle, the resulting fine particles are preferably subjected to the hydrophobizing process without being dried.

The hydrophobizing process is carried out in the following manner: a hydrophobizing agent is sprayed on the fine particles while being vigorously mixed, and after having been mixed for 15 to 30 minutes, the fine particles are baked (heating treatment) at a temperature of 100 to 400° C. for 1 to 6 hours. Depending on cases, acidic water may be sprayed on the fine particles prior to the spraying process of the hydrophobizing process in order to accelerate the hydrophobizing process. With respect to the acidic water, for example, an aqueous solution of hydrochloric acid, adjusted to a pH value of 7 to 1, may be used. The mixing and/or baking process may be carried out in a protective gas atmosphere or in a nitrogen gas.

With respect to the hydrophobic-property applying agent, examples thereof include conventionally-used surface treatment agents such as a silane coupling agent, a titanate coupling agent, silicone oil and silicone varnish, and treatment agents such as a fluorine-based silane coupling agent or fluorine-based silicone oil, a coupling agent having an amino group and a quaternary ammonium salt group, and a modified silicone oil. The hydrophobic-property applying agent may be dissolved in a preferable solvent such as ethanol so as to be applied.

In the present specification, the degree of hydrophobicity was represented by using values obtained in the following method:

Water (50 ml) was put into a beaker of 200 ml, and to this was further added 0.2 g of fine particles of a composite oxide. Methanol was added thereto while being stirred by a magnet stirrer from a buret with its tip being immersed into water upon dripping; thus, the floating fine particles of the composite oxide started to sink, and the number of mls of dripped methanol at the time when the fine particles of the composite oxide had completely sunk was read, and the value was obtained from the following equation:

$$Degree of hydrophobicity = \frac{number of mls of dripped methanol}{50 + number of mls of dripped methanol} \times 100 ( \% )$$

The content of fine particles of the composite oxide in the toner is not particularly limited as long as the effects of the present invention are obtained, and is normally set in a range of 0.1 to 3.0 parts by weight, preferably 0.5 to 2.0 parts by weight, with respect to 100 parts by weight of the toner particles.

In the present invention, besides the above-mentioned composite oxide fine particles, various inorganic/organic fine particles may be externally added to the toner particles. With respect to the inorganic fine particles, examples thereof include: various carbides such as silicon carbide, boron carbide, titanium carbide, zirconium carbide, hafnium carbide, vanadium carbide, tantalum carbide, niobium carbide, tungsten carbide, chromium carbide, molybdenum carbide, calcium carbide and diamond carbon lactam; various nitrides such as boron nitride, titanium nitride and zirconium nitride; bromides such as zirconium bromide; oxides; various oxides such as titanium oxide, calcium oxide, magnesium oxide, zinc oxide, copper oxide, aluminum oxide, silica and colloidal silica; various titanic acid compounds such as calcium titanate, magnesium titanate and strontium titanate; sulfide such as molybdenum disulfide; fluorides such as magnesium fluoride and carbon fluoride; various metal soaps such as aluminum stearate, calcium stearate, zinc stearate and magnesium stearate; and various nonmagnetic inorganic fine particles such as talc and bentonite. These materials may be used alone or in combination. In particular, in the case of the application of inorganic fine particles such as silica, titanium oxide, alumina and zinc oxide, it is preferable to preliminarily carry out a hydrophobic-property applying process thereon by using a hydrophobic-property applying agent in the same manner as the method for the composite oxide fine particles.

The content of inorganic/organic fine particles is normally set in a range of 0.1 to 5 parts by weight, preferably 1 to 3 parts by weight, with respect to the 100 parts by weight of the toner particles. In the case of the application of two or more kinds of inorganic/organic fine particles, the total amount thereof is appropriately set in the above-mentioned range.

With respect to the toner particles of the present invention, those toner particles obtained through a wet granulating method such as a suspension polymerization method, a dispersion polymerization method, a resin-particle association method and an emulsion dispersion method are preferably used. Toner particles, obtained through a wet granulating method, have a higher moisture-absorbing property in comparison with those toner particles obtained through a pulverizing method, and consequently tend to cause a problem of degradation in charging stability (in particular, charging stability with respect to environmental fluctuations); however, the present invention makes it possible to effectively prevent the degradation in charging stability even by the application of those toner particles obtained through the wet granulating method. By manufacturing the toner particles using the wet granulating method, it becomes possible to obtain toner particles having a smaller particle size with a sharp particle size distribution in comparison with those toner particles obtained by the pulverizing method, at low costs. Among the wet granulating methods, the suspension polymerization method and the resin-particle association method are preferably used, and in particular, the resin-particle association method is more preferably used from the viewpoint of degree of freedom in shape-controlling the toner particles.

The following description will discuss a case in which toner particles are manufactured by using the resin-particle association method in detail.

In the resin-particle association method, first, a polymerization composition having a polymerizable monomer is dispersed in an aqueous solvent to be subjected to a polymerizing process so that resin particles having an average particle size in a range of 50 to 1000 nm are formed. Since the particle size of the resin particles is comparatively small, the emulsion polymerization method that easily provides fine particles is preferably adopted as the polymerization method. The following description will discuss a case in which resin particles are formed by using the emulsion polymerization method.

In other words, a polymerization composition containing a polymerizable monomer is dispersed in an aqueous solvent containing a polymerization initiator so that an emulsion polymerizing process is carried out to form resin particles. The emulsion polymerizing process may be carried out in multiple stages to form resin particles. More specifically, the polymerization composition is emulsion-polymerized in an aqueous medium to obtain a fine-resin-particle dispersion solution, and the fine-resin-particle dispersion solution is mixed with an aqueous solvent prepared in a separated manner; thereafter, a polymerization composition, prepared in a separated manner, is further mixed and stirred therein so that a seed emulsion-polymerizing process is carried out. These processes may be carried out repeatedly.

With respect to the polymerizable monomer forming the polymerization composition, a radical polymerizable monomer is used as an essential constituent component with a cross-linking agent being added thereto, if necessary. A radical polymerizable monomer having an acidic group or a radical polymerizable monomer having a basic group, which will be described later, may be contained therein.

With respect to the radical polymerizable monomer, not particularly limited, a conventionally known radical polymerizable monomer may be used. Examples thereof include an aromatic vinyl monomer, a (metha)acrylic acid ester-base monomer, a vinylester-base monomer, vinylether-base monomer, a monoolefin-base monomer, a diolefin-base monomer, a halogenated olefin-base monomer and the like.

With respect to the aromatic vinyl monomer, examples thereof include styrene-base monomers and styrene derivatives such as styrene, o-methylstyrene, m-methylstyrene, p-methylstyrene, p-methoxystyrene, p-phenylstyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, 3,4-dichlorostyrene and the like.

With respect to the (metha)acrylic ester-base monomer, examples thereof include methyl acrylate, ethyl acrylate, butyl acrylate, 2-ethylhexyl acrylate, cyclohexyl acrylate, phenyl acrylate, methyl methacrylate, ethyl methacrylate, butyl methacrylate, hexyl methacrylate, 2-ethylhexyl methacrylate, ethyl β-hydroxy acrylate, stearyl methacrylate and the like.

With respect to the vinyl ester-base monomer, examples thereof include vinyl acetate, vinyl propionate, vinyl benzoate and the like.

With respect to the vinyl ether-base monomer, examples thereof include vinyl methyl ether, vinyl ethyl ester, vinyl isobutyl ether, vinyl phenyl ether and the like.

With respect to the monoolefin-base monomer, examples thereof include ethylene, propylene, isobutylene, 1-butene, 1-pentene, 4-methyl-1-pentene and the like.

With respect to the halogenated olefin-base monomer, examples thereof include vinyl chloride, vinylidene chloride, vinyl bromide and the like.

With respect to the radical polymerizable monomer having an acidic group, example thereof include monomers containing a carboxylic group, a sulfonic group and the like.

With respect to the monomer containing a carboxylic acid group, examples thereof include acrylic acid, methacrylic acid, fumaric acid, maleic acid, itaconic acid, cinnamic acid, monobutyl maleate, monooctyl maleate and the like.

With respect to the sulfonic-acid containing monomer, examples thereof include styrene sulfonate, aryl sulfosuccinate and octyl aryl sulfosuccinate.

These monomers may have a structure of an alkali metal salt such as sodium and potassium or a structure of an alkali earth metal salt such as calcium.

With respect to the radical polymerizable monomer having a basic group, example thereof include amine-based compounds such as primary amine, secondary amine, tertiary amine and quaternary ammonium salt.

With respect to the amine-based compound, examples thereof include dimethyl aminoethyl acrylate, dimethyl aminoethyl methacrylate, diethyl aminoethyl acrylate, diethyl aminoethyl methacrylate, quaternary ammonium salts of these four compounds, 3-dimethyl aminophenyl acrylate, 2-hydroxy-3-methacryloxy propyl trimethyl ammonium salt, acryl amide, N-butyl acryl amide, N,N-dibutyl acryl amide, piperidyl acryl amide, methacryl amide, N-butyl methacryl amide, N-octadecyl acryl amide, vinyl pyridine, vinyl pyrrolidone, vinyl N-methyl pyridinium chloride, vinyl N-ethyl pyridinium chloride, N,N-diaryl methyl ammonium chloride, N,N-diaryl ethyl ammonium chloride, propyl γ-aminoacrylate, dimethyl aminoethyl methacrylate, diethyl aminoethyl methacrylate and the like.

With respect to the radical polymerizable crosslinking agent, examples thereof include those compounds having two or more unsaturated bonds such as divinyl benzene, divinyl naphthalene, divinyl ether, diethylene glycol methacrylate, ethylene glycol dimethacrylate, polyethylene glycol dimethacrylate, diaryl phthalate, butadiene, isoprene and chloroprene. The amount of the radical polymerizable crosslinking agent is preferably set in a range of 0.1 to 10 parts by weight with respect to 100 parts by weight of the entire radical polymerizable monomer.

With respect to the radical polymerization initiator to be added to the aqueous medium, any of those initiators is appropriately used as long as it is water-soluble. Examples thereof include persulfates such as potassium persulfate and ammonium persulfate, azo-based compounds such as 4,4′-azobis-4-cyanovalerate and salts thereof, 2,2′-azobis (2-amidinopropane) salts, peroxide compounds and the like. Each of the above-mentioned radical polymerization initiators may be combined with a reducing agent, if necessary, to form a redox-based initiator. By using a redox-based initiator, the polymerization activity is accelerated so that the polymerization temperature is lowered and the polymerization time is properly shortened.

A surfactant may be preferably added to the aqueous medium. In this case, with respect to the surfactant to be added, although not particularly limited, the following anionic or nonionic surfactants are preferably listed.

With respect to the anionic surfactant, examples thereof include sulfonates such as sodium dodecylbenzene sulfonate and sodium aryl alkyl polyether sulfonate, sulfates such as sodium dodecyl sulfate, sodium tetradecyl sulfate, sodium pentadecyl sulfate and sodium octyl sulfate, fatty acid salts such as sodium oleate, sodium laureate, sodium caprinate, sodium caprylate, sodium capronate, potassium stearate and calcium oleate.

With respect to the nonionic surfactant, examples thereof include polyethylene oxide, polypropylene oxide, a combination of polyethylene oxide and polypropylene oxide, alkyl phenol polyethylene oxide, esters of higher fatty acids and polyethylene glycol, esters of higher fatty acids and polypropylene oxide, sorbitan esters and the like.

With respect to the polymerization temperature, any temperature may be selected as long as it is not less than the lowest radical generation temperature of the polymerization initiator, and it is preferably set in a range of 50 to 90° C. Here, by using a polymerization initiator that initiates the polymerization at normal temperature, such as a combination of hydrogen peroxide/reducing agent (such as ascorbic acid), it is possible to carry out the polymerizing process at room temperature or a temperature higher than room temperature.

After resin particles have been formed, at least the resin particles are aggregated (salt-out), and the resulting aggregated particles are heated and fused to obtain toner particles. Upon aggregation, a dispersion solution containing a colorant and a wax and a charge-controlling agent, if necessary, that are toner constituent components, is mixed with the resin particle dispersion solution so that the toner constituent components may be aggregated together with the resin particles, or upon forming resin particles, the toner constituent components are dissolved or dispersed in a polymerization composition, and this may be subjected to an emulsion-polymerizing process. More preferably, the colorant particles are mixed with the resin particle dispersion solution in the aggregating process, while the wax particles are dissolved in the polymerization composition in the forming process of the resin particles.

In the present specification, the term “aggregation” is used as the concept that at least a plurality of resin particles simply adhere to one another. The “aggregation” forms so-called hetero aggregated particles (group) in which, although constituent particles are made in contact with one another, no bonds caused by fused resin particles and the like are formed. The group of particles, formed by the “aggregation”, is referred to as “aggregated particles”. The term “fusion” is used as the concept that in the aggregated particles, a bond is formed on at least one portion of an interface between the respective constituent particles due to the fusion of the resin particles and the like to form one particle as an unit for use and handling. Here, a group of particles that are “fused” to one another are referred to as “fused particles”. The term “association” is used as the concept including these terms, “aggregation” and “fusion”.

With respect to the aggregation (salting-out) and the fusion, after the aggregating process, the fusing process may be carried out. Alternatively, simultaneously as the aggregating process (salting-out) proceeds, the fusing process may be carried out. In either of the cases, the aggregating process is normally carried out by adding a salting-out agent beyond the critical aggregation concentration. In particular, in the latter case, the salting-out agent is added to water in which, for example, at least resin particles and colorant particles and wax particles, if necessary, are dispersed, beyond the critical aggregation concentration, and by heating this to not less than the glass transition point of the resin particles so that the aggregating process progresses while the fusing process is simultaneously carried out. At this time, an organic solvent, which is infinitely dissolved in water, may be added thereto so as to virtually lower the glass transition temperature of the resin particles; thus, this method makes it possible to carry out the fusing process more effectively.

With respect to the salting-out agent, alkali metal salts and alkali earth metal salts can be used. Alkali metal atoms of such salts include metal atoms of lithium, potassium, sodium and the like, and alkali earth metal atoms of such salts include metal atoms of magnesium, calcium, strontium, barium and the like. Among these, metal atoms of potassium, sodium, magnesium, calcium, barium and the like are preferably used. Here, salts of these alkali metal salts and alkali earth metal salts include chlorates, bromides, iodates, carbonates, sulfates and the like.

With respect to the organic solvent that is infinitely dissolved in water, examples thereof include: methanol, ethanol, 1-propanol, 2-propanol, ethylene glycol, glycerin, acetone and the like; and preferably alcohols such as methanol, ethanol, 1-propanol, 2-propanol and the like, having 3 or less carbon atoms, are used, and more preferably 2-propanol is used.

With respect to the temperature at which the salting-out agent is added, the temperature needs to be set to at least not more than the glass transition temperature of resin particles. The reason for this is explained as follows: In the case when the temperature at which the salting-out agent is added is not less than the glass transition temperature of the resin particles, although aggregating/fusing processes of the resin particles proceed quickly, it becomes difficult to control the particle size, resulting in problems such as generation of particles having a great particle size. The temperature range of the addition is properly set to not more than the glass transition temperature of the resin particles, and is generally set to 5 to 55° C., preferably 10 to 45° C. In a more preferable method, the salting-out agent is added below the glass transition temperature of the resin particles, and this is then quickly heated to not less than the glass transition temperature of the resin particles.

With respect to the colorant, inorganic pigments and organic pigments are preferably used. With respect to the inorganic pigments, conventionally known black pigments and magnetic pigments are listed. Examples of black pigments include carbon black such as furnace black, channel black, acetylene black, thermal black and lamp black, and in addition, magnetic pigments such as magnetite and ferrite, may be used. If desired, these inorganic pigments may be used individually or in combination with a plurality of these. With respect to the added amount of the inorganic pigments, the content in the toner particles is set in a range of 2 to 20% by weight, preferably 3 to 15% by weight, with respect to the entire components. When employed as a magnetic toner, the above-mentioned magnetic pigment may be added. In that case, from the viewpoint of providing specific magnetic properties, the added amount of the magnetic pigment is preferably set so that the content in the toner particles is in a range of 20 to 60% by weight in the entire components.

With respect to the organic pigments, those conventionally known in the art may be used. Any of those organic pigments may be used; and specific organic pigments are exemplified below.

With respect to magenta or red pigments, examples thereof include: C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I. Pigment Red 222 and the like.

With respect to orange or yellow pigments, examples thereof include: C.I. Pigment Orange 31, C.I. Pigment Orange 43, C.I. Pigment Yellow 12, C.I. Pigment Yellow 13, C.I. Pigment Yellow 14, C.I. Pigment yellow 15, C.I. Pigment Yellow 17, C.I. Pigment Yellow 74, C.I. Pigment Yellow 93, C.I. Pigment Yellow 94, C.I. Pigment Yellow 138, C.I. Pigment Yellow 180 and the like.

With respect to cyan or green pigments, examples thereof include: C.I. Pigment Blue 15, C.I. Pigment Blue 15:2, C.I. Pigment Blue 15:3, C.I. Pigment Blue 16, C.I. Pigment Blue 60, C.I. Pigment Green 7 and the like.

If desired, these organic pigments may be used individually or in combination of a plurality of these. With respect to the added amount of the pigments, the content thereof in the toner particles is set in a range of 2 to 20% by weight with respect to the entire components, and is preferably set in a range of 3 to 15% by weight.

In order to surface-modify the colorant, surface modifying agents may be used. With respect to the surface modifying agents for the colorant, those conventionally known in the art may be used. Specific examples thereof include silane coupling agents, titanium coupling agents, aluminum coupling agents and the like.

With respect to the waxes, examples thereof include polyethylene waxes, polyethylene waxes that have been subjected to an acid-modifying treatment (oxidized-type polyethylene waxes), polypropylene waxes, polypropylene waxes that have been subjected to an acid-modifying treatment (oxidized-type polypropylene waxes), paraffin waxes, microcrystalline waxes, carnauba wax, ester waxes and the like. With respect to the ester waxes, the ester wax represented by the following formula is preferably used:
(R¹)₄₋ₙ—C—[(CH₂)ₘ—OCO—R²]ₙ

In the formula, R¹ represents a hydrogen atom or a hydrocarbon group that may have a substituent. R² represents a hydrocarbon group that may have a substituent. Here, n indicates an integer of 1 to 4, preferably 2 to 4, more preferably 3 to 4, still more preferably 4, and m indicates an integer of 1 to 4, preferably 1 to 2, more preferably 1. Preferable hydrocarbon group of R¹ is an alkyl group having carbon atoms of 1 to 40, preferably 1 to 20, more preferably 2 to 5. Preferable hydrocarbon group of R² is an alkyl group having carbon atoms of 1 to 40, preferably 16 to 30, more preferably 18 to 26.

The wax is added through various methods such as a method in which it is added to a polymerization composition in the step for forming resin particles, a method in which it is added simultaneously together with the resin particles and the like in the aggregating (salting-out) process, and a method in which it is directly added to the finished toner. Preferable methods are the above-mentioned method in which the wax is added to a polymerization composition in the step for forming resin particles and the above-mentioned method in which the wax is added simultaneously together with the resin particles and the like in the aggregating (salting-out) process to be contained in the toner.

In addition to the above-mentioned colorant and wax, additives capable of imparting various functions thereto may be added as toner constituent components. Specific examples are a charge-controlling agent and the like. The charge-controlling agent is added in the same method as the wax.

With respect to the charge-controlling agent, those agents that are conventionally known in the art and can be dispersed in water are preferably used. Specific examples thereof include naphthenic acid or metal salts of higher fatty acids, azo-based metal complexes, metal salts of salicylic acid or metal complexes thereof. With respect to the charge-controlling agents, those which form a number-average primary particle size of 10 to 500 nm in a dispersed state are preferably used.

In the present invention, from the viewpoint of charging stability against environmental variations and low costs of the toner, a charge-controlling-agent-less toner that contains no charge-controlling agent is preferably used.

After the aggregating and fusing processes, the toner particles in the resulting aqueous solvent are filtered, and washed with rinsing water so that impurities such as the surfactant and salting-out agent adhering to the toner particles are removed. With respect to the filtering and washing machines to be used in this process, although not particularly limited, for example, a centrifugal separator, a nutsche, a filter press or the like is used.

After the filtering and washing processes, the toner particles are dried. With respect to the drying machine to be used in this process, although not particularly limited, for example, a spray dryer, a reduced-pressure dryer, a vacuum dryer, a ventilation shelf dryer, a movable shelf dryer, a fluidized-bed-type dryer, a rotary dryer, a stirring-type dryer or the like may be used. The amount of moisture in 100 parts by weight of the toner particles that have been dried is preferably set to 5 parts by weight, more preferably not more than 2 parts by weight.

The externally-adding and mixing processes for external additives (composite oxide fine particles and inorganic/organic fine particles, if necessary) with respect to the toner particles, a mixing device such as a Henschel mixer, that applies a shearing force onto the particles to be processed is preferably used. The mixing process is carried out with a prolonged mixing time and/or an increased rotary peripheral speed of the stirring blades. In the case when a plurality of kinds of externally additive agents are used, all the externally additive agents may be mixed with the toner particles in a batch process, or the respective externally additive agents may be mixed therein in a divided manner in a plurality of times.

From the viewpoint of proper charge-controlling properties, the volume-average particle size of the toner is set to 3 to 8 μm, preferably 4 to 7 μm.

With respect to the volume-average particle size of the toner, values measured by a Coulter Multisizer II (made by Beckman Coulter, Inc.) are used; however, the measuring device is not limited by this, and any device may be used as long as the measurements are carried out in the same measuring principle and rules. Here, the toner particle size prior to the externally adding processes remains unchanged from the particle size of the toner after the processes.

With respect to the shape of the toner particles, when the average degree of roundness is small, the toughness is lowered to cause deterioration in the toner earlier; therefore, the average degree of roundness is set to not less than 0.950, preferably 0.950 to 0.990, more preferably 0.950 to 0.980. The average degree of roundness set to such a level makes it possible to suppress generation of fine particles even when a mechanical stress is applied to the toner, and consequently to further improve charging stability and effects of prevention of fogging and filming.

With respect to the average degree of roundness of the toner, values obtained by an FPIA-2000 (made by Sysmex Corp.) are used. However, the measurements are not necessarily carried out by the above-mentioned device, and any device may be used as long as the measurements are carried out in the same measuring principle and rules.

The toner of the present invention may be applied to either of a mono-component developing toner without using carrier and a two-component developing toner used together with carrier; and in particular, it is preferably used as a non-magnetic mono-component and negatively chargeable toner. This is because the composite oxide fine particles used in the present invention are negatively charged easily. In the case of black toners, the toner of the present invention may be either of a magnetic toner and a non-magnetic toner; and in the case of full-color toners, it is preferably used as a non-magnetic full-color toner. Here, in the case of black toner for use in full-color toner, it may be used as either of a magnetic toner and a non-magnetic toner.

Conventionally, when titania is externally added to a mono-component developing toner in combination in addition to silica in an attempt to improve the charging control and charging stability against environmental variations, the charging distribution becomes broader to cause fogging. However, by using the composite oxide fine particles of the present invention, it becomes possible to make the charging distribution sharper to prevent fogging and consequently to improve the charging stability against environmental variations, as well as adjusting the quantity of charge effectively.

With respect to the carrier to be used together with the two-component developing toner, conventionally known carriers may be used, and, for example, any of carriers made from magnetic fine particles such as iron powder and ferrite, coat-type carriers having magnetic particles the surface of which is coated with a coating agent such as resin and binder-type carriers formed by dispersing magnetic particles in a binder resin may be used. With respect to such carriers, those having a volume-average particle size of 20 to 60 μm, more preferably 25 to 50 μm, are preferably used.

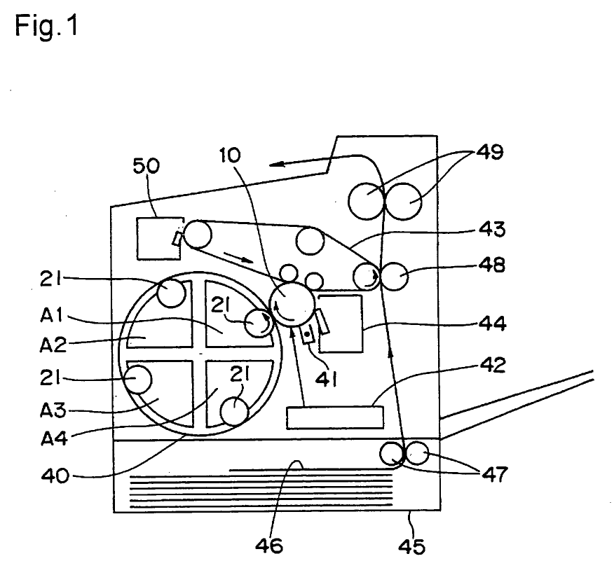

With respect to the method for forming a full-color image by using the toner of the present invention, for example, the following methods are proposed. In other words, as shown in FIG. 1, in a full-color image-forming method of the present invention, four developing devices A1 to A4 are prepared, and the above-mentioned toners of the present invention having different colors of yellow, magenta, cyan and black are housed in the four developing devices A1 to A4. The four developing devices A1 to A4 are held in holders 40 that are allowed to rotate, and the positions of the respective developing devices A1 to A4 are altered by using these holders 40 so that a toner supporting member 21 in each of the developing devices A1 to A4 is successively directed to a position that faces an image-supporting member 10. In the developing area at which the toner supporting member 21 and the image-supporting member 10 are aligned face to face with each other, the toner supporting member 21 and the image-supporting member 10 are shifted upward from below respectively.

Upon forming a full-color toner image, for example, the toner supporting-member 21 of the first developing device A1 housing yellow toner is first positioned so as to face the image-supporting member 10. The image-supporting member 10 is rotated so that the surface of the image-forming member 10 is uniformly charged by a charging device 41; thus, the image-supporting member 10 charged in this manner is subjected to exposure in accordance with an image signal by an exposing device 42 so that an electrostatic latent image is formed on the surface of the image-supporting member 10.

In the developing area at which the image-supporting member 10 bearing the electrostatic latent image formed thereon and the toner supporting member 21 of the first developing device A1 are aligned face to face with each other, the toner supporting member 21 and the image-supporting member 10 are respectively shifted upward from below so that yellow toner is supplied from the toner supporting member 21 to the electrostatic latent image portion formed on the image-supporting member 10; thus, a yellow toner image corresponding to the electrostatic latent image is formed on the image supporting member 10.

The yellow toner image, thus formed on the image-supporting member 10, is pressed and transferred onto an intermediate transferring member 43 prepared as an endless belt that passes over the image supporting member 10, and residual yellow toner on the image-supporting member 10 after the transferring process is removed by a cleaning device 44. Thereafter, the above-mentioned holders 40 are rotated so that the toner supporting member 21 of the second developing device A2 housing magenta toner is positioned so as to face the image-supporting member 10. In the same manner as the first developing device A1, a magenta toner image is formed on the surface of the image-supporting member 10, and the magenta toner image is pressed and transferred onto the intermediate transferring member 43 on which the yellow toner image has been transferred, while residual magenta toner on the image-supporting member 10 after the transferring process is removed by the cleaning device 44. The same processes are carried out so that a cyan toner image is formed on the surface of the image-supporting member 10 by the third developing device A3 housing cyan toner, and the cyan toner image is pressed and transferred onto the intermediate transferring member 43. Furthermore, the same processes are carried out so that a black toner image is formed on the surface of the image supporting member 10 by the fourth developing device A4 housing black toner; thus, this black toner image is pressed and transferred onto the intermediate transferring member 43. In this manner, the respective yellow magenta, cyan and black toner images are successively pressed and transferred onto the intermediate transferring member 43 so that a full-color toner image is formed.

A recording sheet (recording material) 46 is directed by a feeding roller 47 from a paper cassette 45 placed on the lower portion of this color image-forming device to a portion at which the intermediate transferring member 43 and the transferring roller 48 are aligned face to face with each other so that the full-color toner image formed on the intermediate transferring member 43 is pressed and transferred onto the recording sheet 46. The full-color toner image, thus transferred onto the recording sheet 46, is fixed on the recording sheet 46 by a fixing device 49, and the resulting sheet is discharged from the device, and residual toner on the intermediate transferring member 43 without being transferred is removed by the cleaning device 50.

### EXAMPLES

Production of Resin Particles

A solution, preliminarily prepared by dissolving 7.08 g of an anionic surfactant (sodium dodecylbenzene sulfonate: SDS) in ion exchanged water (2760 g), was charged into a 5000 ml separable flask on which a stirring device, a thermo sensor, a cooler and a nitrogen introducing device were attached. The interior temperature thereof was raised to 80° C., while stirring at a stirring speed of 230 rpm under a nitrogen gas flow. Here, the following compound (72.0 g), (CH₃(CH₂)₂₀COOCH₂) C(CH₂OCO(CH₂)₂₀CH₃)₃, was added to a monomer solution composed of 115.1 g of styrene, 42.0 g of n-butyl acrylate and 10.9 g of methacrylic acid, and the mixed solution was heated to 80° C. and dissolved to prepare a monomer solution.

Then the above-mentioned heated monomer solution was mixed and dispersed by a mechanical dispersing machine having a cyclic flow channel to prepare emulsified particles having a uniform dispersion particle size. To this was further added a solution prepared by dissolving 0.90 g of a polymerization initiator (potassium persulfate: KPS) in 200 g of ion exchanged water, and this was heated to 80° C. and stirred for 3 hours to prepare latex particles. Successively, to this was further added a solution prepared by dissolving 8.00 g of the polymerization initiator (KPS) in 240 ml of ion exchanged water, and after a lapse of 15 minutes, to this was dripped a mixed solution of 383.6 g of styrene, 140.0 g of n-butyl acrylate, 36.4 g of methacrylic acid and 13.7 g of t-dodecyl mercaptan at 80° C. in 120 minutes. After completion of the dripping process, this was heated and stirred for 60 minutes, and then cooled to 40° C. to obtain resin particles containing ester wax.

Production of Toner Particles

In 160 ml of ion exchanged water was dissolved 10 g of sodium n-dodecylsulfate. To this solution was gradually added 20 g of C.I. Pigment Blue 15-3 (cyan pigment) while being stirred, and dispersed by using a Clearmix. This dispersion solution was prepared as a cyan colorant dispersion solution.

To a 5-L four-neck flask equipped with a thermo sensor, a cooling tube, a nitrogen introducing device and a stirring device were loaded 1250 g of the above-mentioned resin particles, 2000 ml of ion exchanged water and the colorant dispersion solution, and stirred therein. After having been adjusted to 30° C., a 5 mol/L sodium hydroxide solution was added to this solution so as to adjust the pH of the solution to 10.0. Then, an aqueous solution, prepared by dissolving 52.6 g of magnesium chloride 6 hydrate in 72 ml of ion exchanged water, was added thereto at 30° C. in 5 minutes, while being stirred. After standing for 1 minute, the resulting solution was heated up to 90° C., spending 6 minutes (rate of temperature rise=10° C./minute). In this state, the particle size thereof was measured by a Coulter Counter TA-II, and at the time when a predetermined volume-average particle size had been reached, an aqueous solution, prepared by dissolving 115 g of sodium chloride in 700 ml of ion exchanged water, was added thereto to stop the particle growing, and this was continuously heated at a solution temperature of 90° C.±2° C. for 6 hours while being stirred so that salting-out/fusing processes were carried out. Thereafter, this was cooled to 30° C. at a rate of 6° C./minute, and hydrochloric acid was added thereto to adjust the pH to 2.0, and the stirring process was then stopped. The resulting colored particles were filtered, and washed repeatedly with ion exchanged water, and the resulting particles were then dried with hot air at 40° C. to obtain cyan toner particles having a predetermined volume-average particle size.

Production Examples of Oxide Fine Particles A to S

Metal chlorides 1 and 2 were heated in separated evaporators to be evaporated, and these chloride vapors were introduced into a burner mixing chamber by using nitrogen. Here, these are mixed with hydrogen and dried air and/or oxygen, and burned in a reaction chamber to obtain reactant fine particles. Thereafter, the reactant fine particles were cooled to about 110° C., and successively collected by using a filter. The resulting fine particles were treated at a temperature of 500 to 700° C. by using moistened air so that the adhering chloride was removed to obtain composite oxide fine particles. The mole ratios of the metal chlorides 1 and 2 used in the processes and the BET specific surface areas (m²/g) of the resulting composite oxide fine particles are shown in Table 1.

The composite oxide fine particles were subjected to a hydrophobizing treatment. In other words, the composite oxide fine particles were preliminarily loaded into an appropriate mixing container, and after having been mixed with vigorous stirring, 5 parts by weight of water (pH 7) was added to 100 parts by weight of these composite oxide fine particles, and 10 parts by weight of a hydrophobizing agent (hexamethyl disilazane) was then sprayed thereto, and mixed for 20 minutes. Then, this was subjected to a heating treatment at a temperature of 200° C. for 4 hours, and pulverized. The resulting hydrophobic composite oxide fine particles had the same BET specific surface area as that prior to the hydrophobizing treatment.

TABLE 1

| | Chloride | Chloride | | Ratio of | Ratio of | Hydro- |
|---|---|---|---|---|---|---|
| | 1 | 2 | BET | Chloride 1 | Chloride 2 | phobicity |
| A | SiCl₄ | TiCl₄ | 130 | 47 | 53 | 47 |
| B | SiCl₄ | AlCl₃ | 128 | 45 | 55 | 51 |
| C | SiCl₄ | FeCl₃ | 131 | 44 | 56 | 56 |
| D | SiCl₄ | ZrCl₄ | 130 | 50 | 50 | 47 |
| E | SiCl₄ | NbCl₅ | 139 | 47 | 53 | 45 |
| F | SiCl₄ | VOCl₃ | 125 | 51 | 49 | 53 |
| G | SiCl₄ | WOCl₄ | 131 | 55 | 45 | 60 |
| H | SiCl₄ | SnCl₄ | 122 | 43 | 57 | 51 |
| I | SiCl₄ | GeCl₄ | 135 | 44 | 56 | 51 |
| J | SiCl₄ | TiCl₄ | 122 | 30 | 70 | 53 |
| K | SiCl₄ | TiCl₄ | 135 | 80 | 20 | 52 |
| L | SiCl₄ | TiCl₄ | 7 | 51 | 49 | 56 |
| M | SiCl₄ | TiCl₄ | 56 | 45 | 55 | 49 |
| N | SiCl₄ | TiCl₄ | 197 | 50 | 50 | 61 |
| O | SiCl₄ | TiCl₄ | 298 | 49 | 51 | 52 |
| P | SiCl₄ | TiCl₄ | 55 | 23 | 77 | 52 |
| Q | SiCl₄ | TiCl₄ | 111 | 89 | 11 | 59 |
| R | SiCl₄ | TiCl₄ | 3 | 41 | 59 | 51 |
| S | SiCl₄ | TiCl₄ | 350 | 57 | 43 | 49 |

| | | | | | |
|---|---|---|---|---|---|
| T | SiO₂/TiO₂ combination | 120 | 50 | 50 | 57 |
| U | SiO₂/TiO₂ combination | 130 | 80 | 20 | 46 |
| V | SiO₂/TiO₂ combination | 110 | 20 | 80 | 51 |

In the Table, with respect to oxide fine particles T, U and V, those fine particles obtained as follows were used: In other words, hydrophobic silica (R974; made by Nippon Aerosil Co., Ltd.) having a BET specific surface area of 170 m²/g and hydrophobic titanium oxide (BET specific surface area 100 m²/g), obtained by subjecting anatase-type titanium oxide having an average primary particle size of 20 nm to a surface treatment in an aqueous wet system by isobutyl trimethoxysilane serving as a hydrophobizing agent, were mixed at respective weight ratios of 4:1, 1:1 and 1:4.

### Examples 1 to 22 and Comparative Examples 1 to 7

To 100 parts by weight of toner particles, each having an average particle size and an average degree of roundness shown in Table 2, was added each of oxide fine particles shown in Table 2 at each added amount (number of parts by weight) shown in Table 2, and to this were further added 1.0 part by weight of hydrophobic silica (TS500; made by Cabot Corp.) having a BET specific surface area of 225 m²/g and 2.0 parts by weight of strontium titanate having an average primary particle size of 350 nm with a BET specific surface area of 8 m²/g, and mixed by a Henschel mixer of 9L (FM10B; made by Mitsui Miike Kakouki K.K.) equipped with ST blades as upper blades and A0 blades as lower blades, for 10 minutes at a peripheral speed of 30 m/s to obtain a toner.

TABLE 2

| | | | Toner particles | |
|---|---|---|---|---|
| | Oxide fine particles | | Average | Average |
| | | Addition | particle | degree of |
| | Kind | amount | size (μm) | roundness |
| Example 1 | A | 1.0 | 6.5 | 0.972 |
| Example 2 | B | 1.0 | 6.5 | 0.972 |
| Example 3 | C | 1.0 | 6.5 | 0.972 |
| Example 4 | D | 1.0 | 6.5 | 0.972 |
| Example 5 | E | 1.0 | 6.5 | 0.972 |
| Example 6 | F | 1.0 | 6.5 | 0.972 |
| Example 7 | G | 1.0 | 6.5 | 0.972 |
| Example 8 | H | 1.0 | 6.5 | 0.972 |
| Example 9 | I | 1.0 | 6.5 | 0.972 |
| Example 10 | J | 1.0 | 6.5 | 0.972 |
| Example 11 | K | 1.0 | 6.5 | 0.972 |
| Example 12 | L | 1.0 | 6.6 | 0.973 |
| Example 13 | M | 1.0 | 6.5 | 0.972 |
| Example 14 | N | 1.0 | 6.5 | 0.972 |
| Example 15 | O | 1.0 | 6.6 | 0.972 |
| Example 16 | A | 0.5 | 6.4 | 0.970 |
| Example 17 | A | 2.0 | 6.5 | 0.975 |
| Example 18 | P | 1.0 | 6.5 | 0.972 |
| Example 19 | Q | 1.0 | 6.5 | 0.972 |
| Example 20 | A | 1.0 | 4.5 | 0.973 |
| Example 21 | A | 1.0 | 6.5 | 0.950 |
| Example 22 | R | 1.0 | 6.5 | 0.972 |
| Comparative example 1 | S | 1.0 | 6.5 | 0.972 |
| Comparative example 2 | T | 1.0 | 6.5 | 0.972 |
| Comparative example 3 | U | 1.0 | 6.5 | 0.972 |
| Comparative example 4 | V | 1.0 | 6.5 | 0.972 |
| Comparative example 5 | A | 1.0 | 10.0 | 0.972 |
| Comparative example 6 | T | 1.0 | 4.5 | 0.971 |
| Comparative example 7 | A | 1.0 | 6.5 | 0.946 |

Evaluation

Each of the toners obtained in the respective Examples and Comparative Examples was set to a developing device of a full-color printer (LP-1500C; made by Seiko Epson Corp.), and evaluated with respect to the following points:

Fogging and Charging Stability (Continuous Use)

Continuous printing operations for 5000 copies were conducted on a print pattern having a C/W ratio of 6% under N/N environments (23° C., 45%).

With respect to fogging, initial images and images after endurance printing processes (continuous outputs of 5000 sheets) were visually evaluated.
∘; No fogging occurred;
Δ; Although fogging occurred slightly, no problems were raised in practical use; and
x; Fogging occurred, causing problems in practical use.

With respect to the charging stability upon continuous use, one sheet is allowed to pass through the printer in a white paper mode in the initial state as well as after continuous outputs of 5000 copies, and the quantity of charge was measured with respect to toner on the sleeve by using a suction method, and the evaluation was made based on the difference in quantities of charge between the initial state and the state after continuous outputs of 5000 copies, and classified into the following ranks:
∘; Absolute value of difference in quantities of charge was less than 5 μC/g;
Δ; Absolute value of difference in quantities of charge was in a range of not less than 5 μC/g to less than 10 μC/g; and
x; Absolute value of difference in quantities of charge was not less than 10 μC/g.

Charging Stability (Environmental Fluctuations)

After continuous initial printing operations (50 copies) had been conducted on an image having a C/W ratio of 20% under L/L environments (10° C., 15% RH) as well as under H/H environments (30° C., 85% RH), the image density and fogging on the photosensitive member were visually observed.
∘; Neither degradation in the image density nor fogging occurred under the two types of environments;
Δ; Degradation in the image density and fogging slightly occurred in at least one of the environments; however, no problems were raised in practical use; and
x; Degradation in the image density and fogging occurred in at least one of the environments, causing problems in practical use.

Filming

After continuous printing processes of 5000 copies (after endurance printing processes) under N/N environments (23° C., 45% RH), the surfaces of the photosensitive member and the intermediate transferring member and the resulting images were visually observed and evaluated. Here, the continuous copying processes were carried out on a predetermined print pattern under a condition of a C/W ratio of 6%.
∘; No filming occurred on both of the photosensitive member and intermediate transferring member;
Δ; Filming occurred on at least either of the photosensitive member and the intermediate transferring member; however, no filming appeared on the image, causing no problems in practical use; and

x; Filming occurred on at least either of the photosensitive member and the intermediate transferring member and filming was also observed on the image, causing problems in practical use.

TABLE 3

| | Initial | | | | |
|---|---|---|---|---|---|
| | | Charging stability | Durability | | |
| | | (Environmental | | Charging stability | Filming |
| | Fogging | fluctuations) | Fogging | (Continuous use) | property |
| Example 1 | ◯ | ◯ | ◯ | ◯ | ◯ |
| Example 2 | ◯ | ◯ | ◯ | ◯ | ◯ |
| Example 3 | ◯ | ◯ | ◯ | ◯ | ◯ |
| Example 4 | ◯ | ◯ | ◯ | ◯ | ◯ |
| Example 5 | ◯ | ◯ | ◯ | ◯ | ◯ |
| Example 6 | ◯ | ◯ | ◯ | ◯ | ◯ |
| Example 7 | ◯ | ◯ | ◯ | ◯ | ◯ |
| Example 8 | ◯ | ◯ | ◯ | ◯ | ◯ |
| Example 9 | ◯ | ◯ | ◯ | ◯ | ◯ |
| Example 10 | ◯ | ◯ | ◯ | ◯ | Δ |
| Example 11 | ◯ | ◯ | δ | ◯ | ◯ |
| Example 12 | ◯ | ◯ | ◯ | ◯ | Δ |
| Example 13 | ◯ | ◯ | ◯ | ◯ | ◯ |
| Example 14 | ◯ | ◯ | Δ | ◯ | ◯ |
| Example 15 | ◯ | ◯ | Δ | Δ | ◯ |
| Example 16 | ◯ | ◯ | ◯ | ◯ | ◯ |
| Example 17 | ◯ | ◯ | ◯ | ◯ | ◯ |
| Example 18 | ◯ | ◯ | ◯ | ◯ | Δ |
| Example 19 | ◯ | ◯ | Δ | ◯ | ◯ |
| Example 20 | ◯ | Δ | ◯ | Δ | ◯ |
| Example 21 | ◯ | ◯ | Δ | Δ | ◯ |
| Example 22 | Δ | Δ | Δ | Δ | X |
| Comparative example 1 | Δ | Δ | X | X | X |
| Comparative example 2 | X | Δ | X | Δ | X |
| Comparative example 3 | X | X | X | X | X |
| Comparative example 4 | X | X | X | Δ | X |
| Comparative example 5 | X | ◯ | X | X | X |
| Comparative example 6 | X | X | X | Δ | X |
| Comparative example 7 | Δ | ◯ | X | X | X |

1. A toner comprising:
toner particles that are manufactured by a wet granulating method and contain a binder resin and a colorant; and
composite oxide fine particles having a specific surface area of not more than 300 m²/g, that contain two kinds or more of metal atoms selected from the group consisting of metal atoms that belong to 4A to 7A groups, 8 group and 1B to 4B groups in the long-period-type element periodic table.

2. The toner according to claim 1, wherein the composite oxide fine particles contain two kinds or more of metal atoms selected from the group consisting of Si, Al, Ti, Zr, Fe, Nb, V, W, Sn and Ge.

3. The toner according to claim 2, wherein the composite oxide fine particles comprises Si atom.

4. The toner according to claim 3, wherein the composite oxide fine particles comprises Si atom and Ti atom.

5. The toner according to claim 1, wherein the toner particles are manufactured by a resin-particle association method.

6. The toner according to claim 1, wherein the toner particle has an average degree of roundness of not less than 0.950.

7. The toner according to claim 6, wherein the toner particle has an average degree of roundness of 0.950-0.980.

8. The toner according to claim 1, wherein the specific surface area is 30-250 m²/g.

9. The toner according to claim 1, wherein the composite oxide fine particles are constituted by two kinds of metal oxides and the ratio of contents between one metal oxide and the other metal oxide is set to 1:9 to 9:1.

10. The toner according to claim 1, wherein the composite oxide fine particles are subjected to a hydrophobizing process to have a degree of hydrophobicity of not less than 20%.

11. The toner according to claim 1, wherein the content of composite oxide fine particles is in a range of 0.1 to 3.0 parts by weight with respect to 100 parts by weight of the toner particles.

12. The toner according to claim 1, wherein fine particles besides the composite oxide fine particles are externally added.

13. The toner according to claim 12, wherein a content of the fine particles is in a range of 0.1 to 5 parts by weight with respect to 100 parts by weight of the toner particles.

14. The toner according to claim 1, wherein the colorant is a pigment and the content thereof in the toner particles is in a range of 2 to 20% by weight with respect to the entire components.

15. The toner according to claim 1, wherein the toner is a non-magnetic mono-component and negatively chargeable toner.

16. An image forming method, comprising:
forming an electrostatic latent image on surface of an image-supporting member,
forming a toner image on the image-supporting member; and
transferring the toner image to a recording medium,
the toner comprising toner particles containing a binder resin and a colorant; and
composite oxide fine particles having a specific surface area of not more than 300 m²/g, that contain two kinds or more of metal atoms selected from the group consisting of metal atoms that belong to 4A to 7A groups, 8 group and 1B to 4B groups in the long-period-type element periodic table.

17. The image forming method according to claim 16, wherein the process of transferring the toner image on the image-supporting member to the recording member comprises;
transferring the toner image on the image-supporting member to an intermediate transferring member; and
transferring the toner image on the intermediate transferring member to the recording medium.

18. The image forming method according to claim 17, wherein plural toners for forming full color image are used and the transferring process of the toner image on the image-supporting member to the intermediate transferring member is carried out with respect to each color toner.

19. The image forming method according to claim 16, being a mono-component developing system.
